(19) United States
(12) Patent Application Publication
(10) Pub. No.: US 2014/0222578 A1
(43) Pub. Date: Aug. 7, 2014

(54) DIGITAL SIGNAGE MANAGEMENT SYSTEM

(71) Applicants: Rajesh Poornachandran, Portland, OR (US); Gyan Prakash, Beaverton, OR (US); Nagasubramanian Gurumoorthy, Portland, OR (US); Kaitlin A. Murphy, Hillsboro, OR (US); Lokesh Thutaram, Bangalore (IN)

(72) Inventors: Rajesh Poornachandran, Portland, OR (US); Gyan Prakash, Beaverton, OR (US); Nagasubramanian Gurumoorthy, Portland, OR (US); Kaitlin A. Murphy, Hillsboro, OR (US); Lokesh Thutaram, Bangalore (IN)

(21) Appl. No.: 13/995,220

(22) PCT Filed: Jun. 11, 2012
(86) PCT No.: PCT/US2012/041896

§ 371 Date: Apr. 11, 2014

(51) Int. Cl. G06Q 30/02

(52) U.S. Cl. CPC G06Q 30/0264
USPC 705/14.61

(57) ABSTRACT

Generally, this disclosure describes a digital signage management system. The system may include a user device including processor circuitry coupled to communication circuitry, the communication circuitry configured to couple the user device to at least one of a digital sign and a management service, and the user device configured to manage display of user content on the digital sign, the user content configured to be displayed on the digital sign in a time slot.

### FIELD

This disclosure relates to digital signage, more particularly digital signage management system.

### BACKGROUND

Advertisement billboards include digital signage positioned at locations where people may be waiting such as at restaurants, shopping malls and airports. The digital signage typically includes lit displays and are programmable.

Digital signage may be rented by advertisers for relatively long time periods, for example, on the order of weeks or months. Advertisers may typically negotiate with and provide advertising content to an owner/manager of digital signage. The owner/manager may then manage display of the advertising content. If the advertiser wishes to change the advertising content or change a location for displaying the advertising content, then the advertiser may renegotiate with the owner(s)/manager(s) of the signage. Such a process can be time-consuming.

The advertiser may be unable to quickly and efficiently modify the advertising content or to display content for different time intervals, e.g., to respond to customer feedback. Further, the advertiser may be limited to known digital signage near the advertisers' geographic location. Thus, although digital signage is more versatile over traditional billboards, scheduling and managing its usage can be time consuming and inefficient.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system block diagram of a digital signage management system consistent with an embodiment of the present disclosure;

FIG. 2 illustrates a flowchart for a user to schedule and/or bid for advertising time slot(s) consistent with an embodiment of the present disclosure;

FIG. 3 illustrates a flowchart for a digital signage manager related to scheduling advertising time slots consistent with an embodiment of the present disclosure;

FIG. 4 illustrates a flowchart for display management of digital signage by a user consistent with an embodiment of the present disclosure; and

FIG. 5 illustrates a flowchart for local scheduling of advertising time slot(s) in digital signage by a user consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes a system and method for scheduling time slot(s) for displaying advertising and/or other user content on digital signage, obtaining approval of advertising and/or other user content and managing the display once scheduled. The system and method are configured to allow a user (e.g., advertiser) to select and/or bid for time slot(s) on identified digital signs, to upload user content and then to manage and/or change display of the content. For example, changing the display may include adjusting order of display of content, changing the content to be displayed and/or adjusting content to be displayed between digital signs.

“Digital signs” and “digital signage” include, but are not limited to, digital advertising billboards, digital advertising boards and/or other digital signs configured to display user content. User content includes, but is not limited to, advertising, captured images of an event (e.g., a graduation, a wedding, a celebration and/or other event), and or other user content. User content may include a plurality of discrete segments with each segment corresponding to a portion of the user content. For example, for advertising content, each segment may correspond to an advertisement for a different product and/or service. As used herein, “time slot” corresponds to a time interval in a display schedule of a digital sign.

The scheduling and managing may be performed by a user using a user computing device coupled to a digital sign management service and/or digital sign. The method and system are configured to allow the user to submit content to the digital sign management service using the user device for review and approval. The user may then manage display of the approved content across time slot(s) (and/or digital sign(s)) that the user has reserved and/or purchased. The digital sign management service may provide access to a plurality of digital signs at a variety of geographic locations.

In one embodiment, a user may discover a digital sign while at a location that includes the digital sign. The user may access the discovered digital sign using the user computing device, schedule displaying of user content and upload the user content. The user may then confirm the upload while at the location. In this embodiment, the schedule and uploaded user content may be provided to the digital sign management service by the digital sign.

Thus, a user may conveniently and efficiently access a plurality of digital signs at potentially diverse geographic locations for scheduling. The user may then easily manage and/or change displayed content in scheduled time slot(s) without a cumbersome renegotiation process. Owners/managers of digital signage may then benefit from this ease of scheduling and user management by greater usage and demand for advertising time slot(s) associated with digital signs.

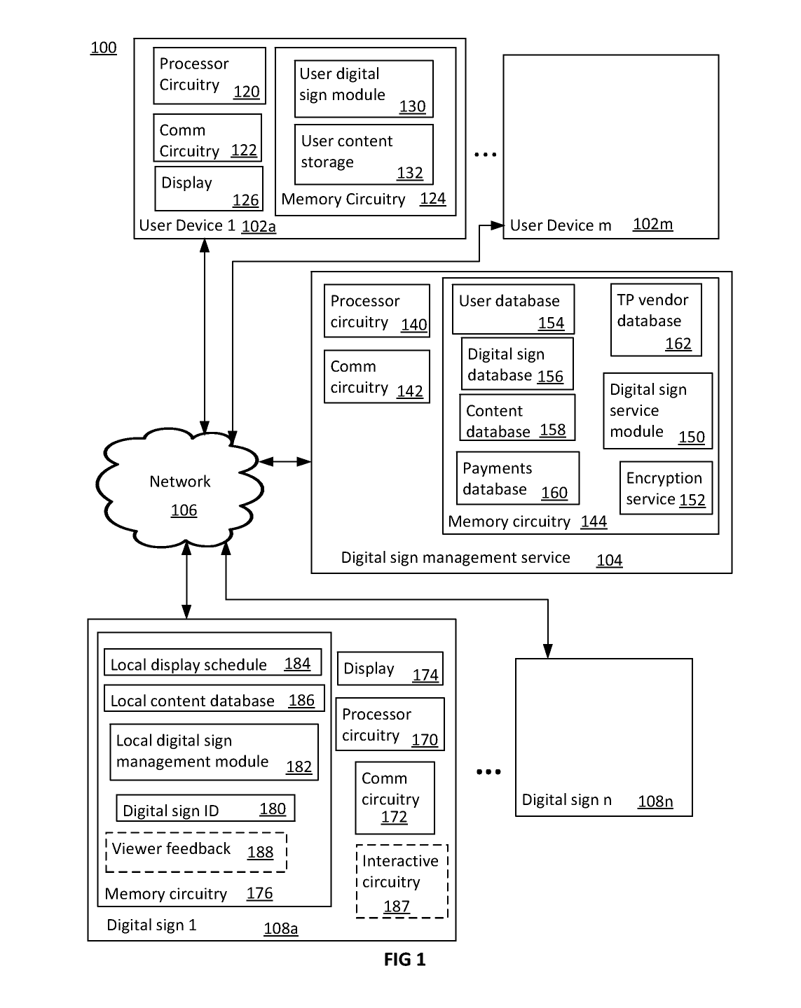

FIG. 1 illustrates a block diagram 100 of a digital signage management system consistent with an embodiment of the present disclosure. The digital signage management system 100 includes one or more user device(s) 102a, . . . , 102m, a digital sign management service 104, network 106 and one or more digital signs 108a, . . . , 108n. System 100 is configured to provide access to a plurality of digital signs at potentially diverse locations by one or more user(s) utilizing associated user device(s) 102a, . . . , 102m, as described herein.

Although only user device 102a is illustrated in detail, each user device 102a, . . . , 102m is generally similar to each other user device 102a, . . . , 102m. Thus, user device 102a refers to any of the user device(s) 102a, . . . , 102m. “User device” includes any computing device, handheld, portable and/or stationary, including, but not limited to, mobile telephones, smartphones, desktop computers, all-in-one computers, tablet computers, notebook computers, ultraportable computers, ultramobile computers, netbook computers, subnotebook computers, personal digital assistants, enterprise digital assistants and mobile internet devices.

User device 102a generally includes processor circuitry 120, communication circuitry 122, memory circuitry 124, and display 126. Processor circuitry 120 may include one or more processor(s) and is configured to perform one or more operations related to scheduling and/or managing display of user content. Communication circuitry 122 is configured to couple user device 102a to digital sign management service 104 and/or one or more digital signs 108a, . . . , 108n, via, for example, network 106. Communication circuitry 122 may be configured to communicate using one or more communication protocols, wired and/or wireless, including but not limited to NFC, RFID, Wi-Fi, Bluetooth, 3G, 4G and/or other communication protocols. Display circuitry 126 is configured to display schedule(s), bid status and/or other data associated with digital signage management, as described herein.

Memory circuitry 124 may include user digital sign module 130 and/or user content storage 132. Digital sign module 130 is configured to manage access to digital sign management service 104 and/or the digital sign(s) 108a, . . . , 108n and to display data associated with digital signage management to an associated user. User digital sign module 130 is configured to allow the associated user to select and/or bid for desired time slot(s) for selected digital sign(s) 108a, . . . , 108n, to upload content for review and approval and to then manage adjusting display of approved content in the selected time slot(s). User content storage 132 may include unapproved, not yet approved and/or approved user content. The user content is configured to be displayed on one or more digital signs 108a, . . . , 108n.

Digital sign management service 104 includes processor circuitry 140, communication circuitry 142 and memory circuitry 144. Digital sign management service 104 may correspond to one or more servers in a plurality of servers, i.e., may be in the cloud. Processor circuitry 140 may include one or more processor(s) and may be coupled to communication circuitry 142 and memory circuitry 144. Processor circuitry 140 is configured to perform the operations of digital sign management service 104 associated with digital signage management. Communication circuitry 142 is configured to couple digital sign management service 104 to user device(s) 102a, . . . , 102m and digital sign(s) 108a, . . . , 108n. Communication circuitry 142 may be configured to communicate with user device (s) 102a, . . . , 102m, network 106 and digital sign(s) 108a, . . . , 108n, using a variety of communication protocols wired and/or wireless, as described herein.

Memory circuitry 144 may include digital sign service module 150, encryption service 152, user database 154, digital sign database 156, content database 158, payments database 160 and/or third party vendor database 162. Digital sign service module 150 is configured to manage operations of digital sign management service 104. Digital sign service module 150 is configured to communicate with user device(s) 102a, . . . , 102m, for example, to provide a listing of digital signs that may have available and/or biddable time slot(s). The listing may be provided in response to a request from a user via an associated user device, e.g., user device 102a.

Digital sign service module 150 is configured to maintain a list of users in user database 154. User database 154 may include a list of user identifiers, a usage history associated with each user identifier and/or a request history associated with each user identifier. Digital sign service module 150 is configured to maintain a listing of digital signs 108a, . . . , 108n in digital sign database 156. Digital sign database 156 may include a list of digital sign identifiers, a schedule of time slots, a price listing associated with each time slot, an indicator whether a time slot is available, auctionable, reserved and/or purchased, a usage history associated with each digital sign and/or location characteristics including a geographic location indicator, type of environment and statistical data (e.g., demographics) associated with people who may view the digital sign.

The geographic location indicator may include, but is not limited to, a street address, a business name, GPS coordinates and/or some other location indicator. Type of environment may include, but is not limited to, public transportation entity, restaurant, shopping mall, school and/or other types of environments where a digital sign may be located. Public transportation entity may include, but is not limited to, an airport, a train station, a bus station and/or a subway station. Public transportation entities may include one or more movable public transportation components, including but not limited to, rail passenger car(s), bus(es), and/or subway cars. The geographic location indicator associated with a movable public transportation component may include a range of locations corresponding to a route of the movable public transportation component.

The usage history associated with each digital sign may include statistical usage data such as a frequency that a time slot is occupied or available, and a frequency that a time slot is already reserved by one user when requested by another user. Such data may be utilized, for example, for determining pricing for the time slots. The location indicator characteristics may be utilized for determining pricing for time slots.

Determining whether submitted user content is approved or not may be based, at least in part, on location characteristics. For example, user content displayed near a night club may be directed to an adult audience while user content displayed near a playground may be configured to reflect the likelihood that children will view the user content. Thus, user content directed to an adult audience may not be approved for a digital sign in view of the playground but may be approved for a digital sign near a nightclub.

Thus, the digital sign database 156 may be configured to include, not only data related to a current schedule and pricing of digital sign time slots, but also location characteristic data that may be utilized in setting future prices. digital sign time slots that are in relatively high demand may, for example, be auctioned. Allowing potential users to bid for an in demand time slot may beneficially permit the market to establish the price for the time slot. Such auctions may be conducted in real-time.

Content database 158 is configured to include user content that may include a plurality of segments, each segment corresponding to a portion of the user content. The user content may be related to a user identifier associated with the user that submitted the content. The user content may be categorized as submitted (i.e., not yet approved), approved or rejected. Content database 158 may further include qualifiers associated with approved content. For example, for advertising content, the qualifiers may be configured to indicate characteristics (e.g., age range) of target viewers of the advertising. Content database 158 may further include a digital sign identifier and time slot identifier for user content that is currently scheduled for display.

Content that has been approved may be encrypted and/or digitally signed using, for example, encryption service 152. Encrypting and/or digitally signing is configured to ensure that only approved and authorized content is uploaded to and displayed on a digital sign 108a, . . . , 108n.

Digital sign service module 150 is configured to maintain the payments database 160. Payments database 160 is configured to include a record of payments for each digital sign 108a, . . . , 108n The records may include a digital sign identifier and payment data for each time slot associated with the digital sign. Payment data may include, but is not limited to, an indicator whether a time slot is reserved and payment has not been received or the time slot is reserved and payment has been received, a final bid price for time slots that have been auctioned, a price for non-auctioned (i.e., fixed price) time slots and/or other payment data.

Third party vendor database 162 is configured to include a list of third party vendors authorized to approve content for display. For example, a user that wishes to rent a selected digital sign, e.g., digital sign 108a, to display an event in real-time may utilize an authorized third party vendor. The event may include, but is not limited to, a graduation, a wedding, a birthday celebration, some other celebration, and/or some other event. The user may select an authorized third party vendor to capture (e.g., videotape and/or digital video recording) the event and to upload the captured image in real-time to selected digital sign 108a. Thus, a live event may be displayed on a digital sign with content approval implemented in real-time via a third party vendor.

Alternatively or additionally, content from a live event may be captured and analyzed on-the-fly for approval. Display of approved content may occur after a delay configured to allow analysis and approval of the content. For example, the delay may be on the order of seconds. Thus, a “live” event may be displayed on a digital sign after a delay with content approval implemented in nearly real-time.

Thus, a user, via an associated user device, e.g., user device 102a, may access digital sign management service 104 in order to determine availability of a desired time slot of a selected digital sign 108a, . . . , 108n. The user may request a price associated with the desired time slot and/or bid for the desired time slot. The user may reserve the desired time slot, upload content for approval or utilize a third party vendor for real-time approval of live content and/or pay for the reserved time slot. The digital sign management service 104 may then maintain records of transactions associated with selecting, renewing and purchasing time slots, uploading content for approval and display of the content.

Digital signage management system 100 includes one or more digital signs 108a, . . . , 108n (digital signage). Although only digital sign 108a is illustrated in detail, each digital sign 108a, . . . , 108n is generally similar to each other digital sign 108a, . . . , 108n. Thus, digital sign 108a refers to any of the digital sign(s) 108a, . . . , 108n.

Digital sign 108a generally includes processor circuitry 170, communication circuitry 172, display 174 and memory circuitry 176. Processor circuitry 170 is configured to perform operations of digital sign 108a associated with digital signage management system 100. Communication circuitry is configured to couple digital sign 108a to digital sign management service 104, user device(s) 102a, . . . , 102m and/or network 106. Communication circuitry 172 may be configured to communicate with digital sign management service 104, user device(s) 102a, . . . , 102m and/or network 106 using one or more communication protocols, as described herein.

Display circuitry 174 is configured to display user content. For example, display circuitry 174 may display approved advertising content. In another example, display circuitry 174 may display live event content approved by, for example, a third party vendor, as described herein. Display circuitry 174 may include lights and/or light emitting diodes (LEDs) and is generally programmable allowing nearly instantaneous changes in displayed content.

Memory circuitry 176 generally includes a digital sign identifier 180, a local digital sign management module 182, a local display schedule 184, and local content database 186. The digital sign identifier 180 is configured to uniquely identify the digital sign. The local digital sign management module 182 is configured to manage operation of the digital sign 108a. The local digital sign management module 182 may communicate with the digital sign management service 104 to, for example, acquire and/or update the local display schedule 184. The local digital sign management module 182 may communicate with the digital sign management service to acquire content to be displayed. The content to be displayed may then be stored in the local content database 186. The local digital sign management module 182 is configured to display content from the local content database 186 on display 174 according to the local display schedule 184.

The local digital sign management module 182 is configured to synchronize the local display schedule 184 with a related schedule stored in the digital sign database 156 that is maintained by digital sign management service 104. The local digital sign management module 182 may be configured to synchronize user content stored in the local content database 186 with user content stored in content database 158 of digital sign management service 104.

In some embodiments, digital sign 108 may include interactive circuitry 187 and viewer feedback database 188. Interactive circuitry 187 is configured to request and receive viewer feedback. For example, a request for viewer feedback may be displayed on display 174. A plurality of possible responses may also be displayed, each possible response selectable by a viewer. Interactive circuitry 187 is configured to capture each viewer response and to store a representation of the viewer response in viewer feedback database 188. The representation may be communicated to digital sign management service 104. A user device, e.g., user device 102a, associated with the displayed content may be configured to retrieve the representation from digital sign 108 and/or digital sign management service 104. In an embodiment interactive circuitry 187 may be configured to notify the user device 102a when a representation of one or more viewer responses are stored in the viewer feedback database 188. Thus, a user may receive real-time feedback from viewers of content displayed on digital sign 108a. The user may then adjust the content and/or order of display in real-time based on the feedback using a method and system consistent with the present disclosure.

After a user has reserved and paid for time slot(s) associated with one or more digital signs 108a, . . . , 108n and the content to be displayed has been approved, the user may wish to manage display of the content. For example, the user may wish to adjust (i.e., change) an order that the content (e.g., portions of content) is displayed in selected time slot(s). In another example, the user may wish to display different and/or updated content in a reserved time slot. A method and system consistent with the present disclosure is configured to facilitate user management of display of content on digital sign(s) 108a, . . . , 108n. In an embodiment, the user may access digital sign management service 104 via user device 102a. The user may then adjust display order of associated content and/or portions of associated content and/or upload new content for approval prior to displaying the new content. In another embodiment, the user may access a selected digital sign 108a, . . . , 108n via user device 102a. The selected digital sign 108a, . . . , 108n may be scheduled to display the user's content. The user may then adjust display order of portions of associated content. Thus, the user may manage display of content after initial scheduling via digital sign management service 104.

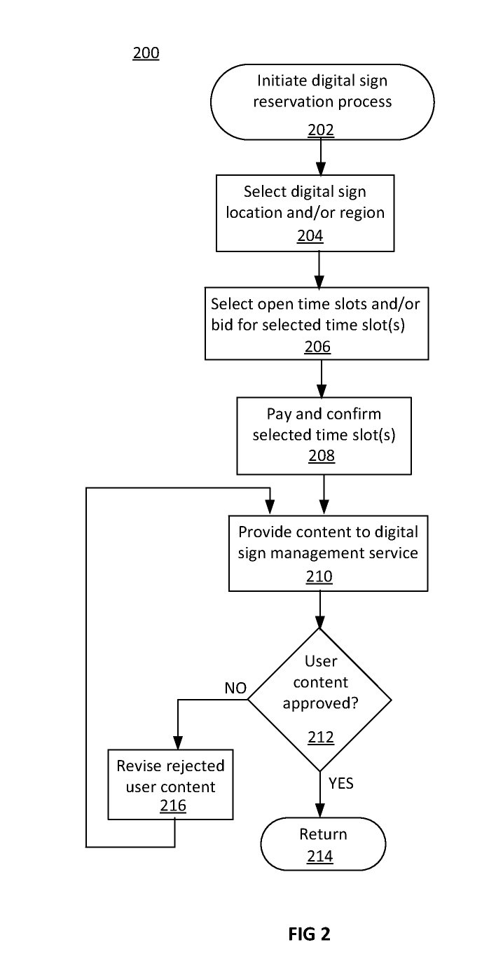

FIG. 2 illustrates a flowchart 200 of exemplary operations consistent with an embodiment of the present disclosure. The operations may be performed, for example, by user device 102a, . . . , 102m and/or digital sign management service 104. In an embodiment, the operations may also be performed by digital sign(s) 108a, . . . , 108n. In particular, flowchart 200 depicts exemplary operations configured to schedule time slot(s) and upload content for approval for display on a digital sign.

Program flow may begin with operation 202, initiating a digital sign reservation process. For example, a user may initiate the reservation process by using an associated user device to access the digital sign management module 104. A digital sign geographic location may be selected at operation 204. The geographic location may be selected based on a geographic location indicator. Operation 206 may include selecting open time slot(s) and/or bidding for selected time slot(s). For example, the digital sign management service 104 may provide a listing of available time slot(s) and/or time slot(s) being auctioned in response to receiving the user's selection of geographic locations. The time slot(s) may correspond to digital sign(s) in the geographic location initially selected by the user. The user may then select an open time slot or bid for a desired time slot based, at least in part, on this listing.

Operation 208 may include paying for and confirming the selected time slot(s). For example, time slot(s) may be purchased electronically and confirmation may be indicated by receipt of a confirmation number. User content to be displayed may be provided to the digital sign management service for approval at operation 210. For example, the user content may be transported from user content storage 132 in user device 102a to digital sign management service 104. In another example, for advertising content, the advertising content may be retrieved from an advertising agency and provided to digital sign management service 104. In both examples, the user content may be supplied to the digital sign management service a time period before a first scheduled display time (i.e., time slot). The time period is configured to provide sufficient time for review and approval of the user content. In another example, if the user content corresponds to a live event, content may be provided for approval on-the-fly or may be approved in real time by a third party vendor, as described herein. In this example, the user content may be supplied during the scheduled display time.

Whether the content is approved may be determined at operation 212. If the content is approved program flow may end at operation 214. If the content is not approved, the rejected content may be revised at operation 216. Program flow may proceed to operation 210 and the content may be provided to the digital sign management service for approval.

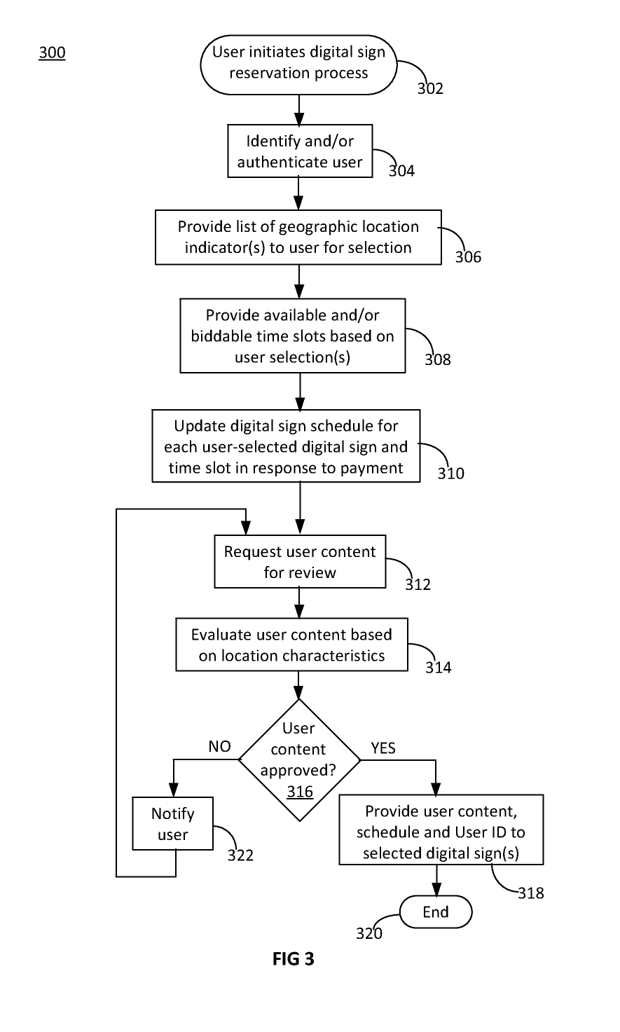

FIG. 3 illustrates a flow chart 300 of exemplary operations consistent with an embodiment of the present disclosure. The operations may be performed, for example, by digital sign management server 104. In an embodiment the operations may be performed by digital sign 108a, . . . , 108n. In particular, flowchart 300 depicts exemplary operations configured to schedule display of user content on selected digital sign(s) and to analyze user content for approval or rejection.

The operations of flowchart 300 may be initiated when a user initiates 302 a digital sign reservation process configured to schedule a time slot for displaying user content on a digital sign. Operation 304 may include identifying and/or authenticating the user. A list of geographic location indicators may be provided to the user at operation 306. The list of geographic location indicators may correspond to geographic locations that include digital sign(s). The list of geographic location indicators may be supplied to user device 102a by digital sign management service 104. In some embodiments, other location characteristics may be provided associated with the geographic location indicators. The location characteristics are configured to allow a user to choose digital sign(s) at location(s) that are appropriate for display of the user's content. Operation 308 includes providing a listing of available and/or biddable time slot(s) based at least in part on a user's selection of geographic locations.

A digital sign schedule may be updated for each user-selected digital sign and time slot in response to a payment from the user at operation 310. For example, a digital sign schedule stored in the digital signdatabase 156 of digital signmanagement service 104 may be updated. In another example, a local digital signdisplay schedule, (e.g., local display schedule 184) may be updated.

Operation 312 may include requesting user content for review. Received user content may be evaluated based on location characteristics at operation 314. Whether the user content is approved may be determined at operation 316. If the user content is approved, the user content, schedule and possibly an associated user identifier may be provided to the selected digital sign(s) at operation 318. The user content may be encrypted and/or digitally signed prior to being provided to the selected digital sign(s). Program flow may end at operation 320. If the user content is not approved, the user may be notified at operation 322. Program flow may then proceed to operation 312, request user content for review.

Thus, the operations of flowcharts 200 and 300 are configured to allow a user using an associated user device to select one or more digital sign(s) for display of user content, reserve time slot(s) in the selected digital sign(s) and upload content to the digital sign management service for approval. The user may select from a plurality of digital signs according to location characteristics. In an embodiment, in-demand time slot(s) may be auctioned. The operations of flowcharts 200 and 300 are further configured to allow the user to bid in such an auction.

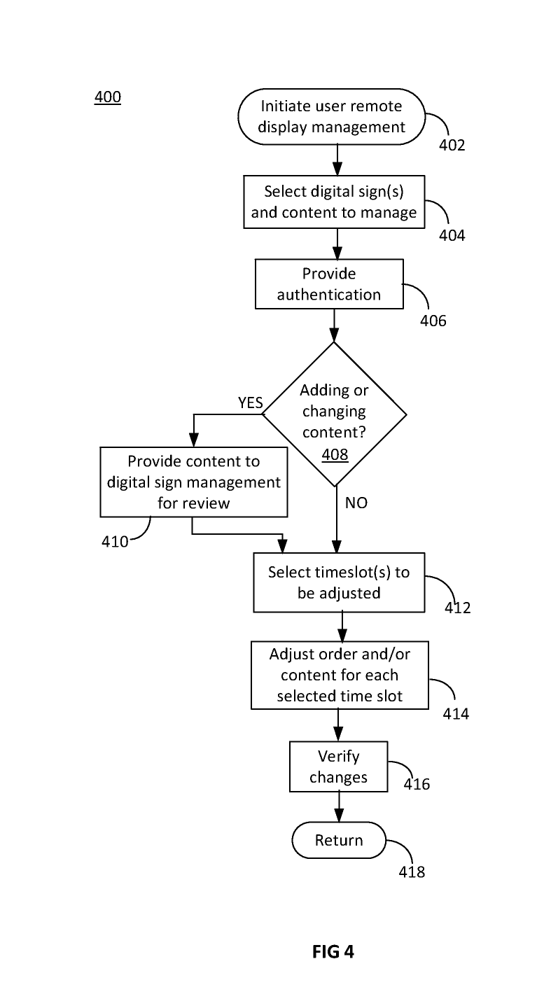

FIG. 4 illustrates a flow chart 400 of exemplary operations consistent with an embodiment of the present disclosure. The operations may be performed, for example, by user device 102a. In particular, flowchart 400 depicts exemplary operations configured to manage display of user content including but not limited to adjusting order of display of user content and/or portions of user content in a time slot, adjusting content for display between time slot(s) and/or digital sign(s), and/or updating user content.

The operations of flowchart 400 may begin 402 with a user initiating remote display management. For example, the user may initiate remote display management by launching an application on a user device. digital sign(s) and content to be managed may be selected at operation 404. Operation 406 may include providing authentication. For example, a user may be requested to provide authentication by digital sign management service. In another example, a user may be requested to provide authentication by the selected digital sign(s).

Operation 408 may include determining whether content will be added and/or changed. If content will be added and/or changed, the content may be provided to digital sign management server for review at operation 410. The time slot to be adjusted may be selected at operation 412. The time slot to be adjusted may be related to the content. A display order and/or content for each selected time slot may be adjusted at operation 414. Changes may be verified at operation 416. Program flow may end (return) at operation 418.

Thus, the operations of flowchart 400 are configured to allow a user using an associated user device to manage display of user content on one or more digital sign(s). Using user device 102a, the user may select a digital sign to manage, add and/or change content to be displayed and/or adjust a display order of content in a selected time slot. Such a process is configured to provide a relatively efficient option to the user for management of user content configured to be displayed on a digital sign.

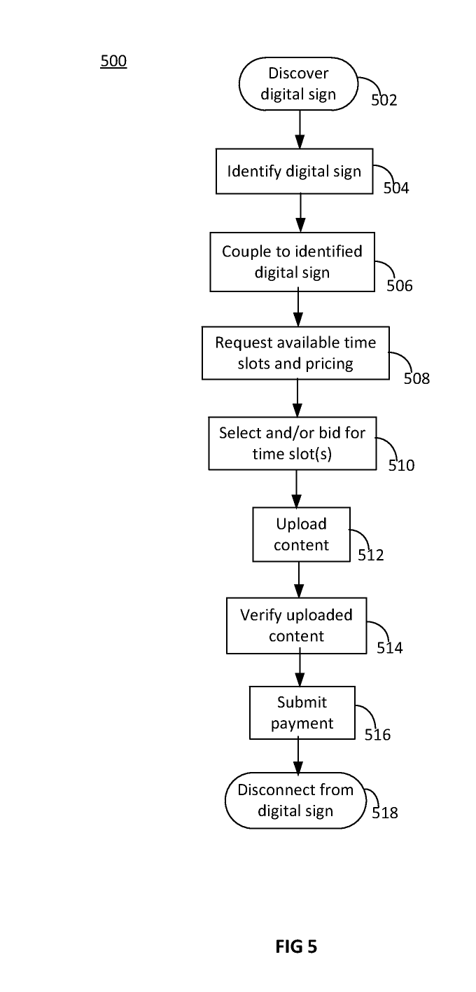

FIG. 5 illustrates a flowchart 500 of exemplary operations consistent with an embodiment of the present disclosure. The operations may be performed, for example, by user device 102a, . . . , 108n. In particular, flowchart 500 depicts exemplary operations configured to allow a user to schedule display of content and upload content directly with a discovered digital sign. The user and user device 102a may be near the digital sign during this process.

The operations of flowchart 500 may begin with a user discovering 502 a digital sign. For example, the user may travel to a location near the digital sign. The digital sign may be identified at operation 504. For example, the digital sign may include a bar code identifier. In another example, the digital sign may include a unique identifier that is visible to a user. In another example, the digital sign may be configured to communicate with a local user device using, for example, a Bluetooth signal that may include a unique identifier.

Operation 506 may include coupling to the identified digital sign. For example, the user may connect to the identified digital sign via an associated user device. Available time slot(s) and associated pricing may be requested at operation 508. For example, the identified digital sign may be configured to determine available time slot(s) based on data stored in a local display schedule. An available time slot may be selected and/or bid(s) may be placed for biddable time slot(s) at operation 510. Biddable time slot(s) may correspond to in demand time slot(s).

Advertising and/or other user content may be uploaded at operation 512. For example, the user content may be transferred from a user device to the digital sign. The uploaded user content may be verified at operation 514. For example, verification may include displaying the uploaded content on the digital sign display for the user to review. The user may then be able to ensure the integrity of the uploaded content. Payment may be submitted at operation 516. Program flow may then end at operation 518 by disconnecting from the digital sign.

Thus, operations of flowchart 500 are configured to allow a user to access to a local digital sign to schedule a display of content, upload the content and extend payment for the display. Such a user may have firsthand knowledge of a type and number of people that may view the digital sign display. Further, providing local access facilitates scheduling display and uploading content to a digital sign with known location characteristics.

Thus, a method and system consistent with the present disclosure is configured to facilitate (allow) digital signage management for user(s). The user(s) may access a digital sign and/or the digital sign management service via their associated user devices. The user(s) may then reserve, bid for and/or purchase time slot(s) for displaying content on user-selected digital sign(s), via their associated user device(s).

Content may then be uploaded for approval prior to display. The approval is configured to ensure that the content is appropriate for the selected digital sign(s). Additionally or alternatively, an image of a live event may be displayed with real-time approval by a third party vendor or after a delay for on-the-fly approval.

The user may then manage display of the uploaded content. For example, the display order in a time slot may be adjusted. In another example, the content selected for display may be adjusted e.g., may be changed. Managing display of the uploaded content may thus be relatively simple and convenient for the user.

While FIGS. 2 through 5 illustrate various operations according one embodiment, it is to be understood that not all of the operations depicted in FIGS. 2 through 5 are necessary for other embodiments. Indeed, it is fully contemplated herein that in other embodiments of the present disclosure, the operations depicted in FIGS. 2 through 5 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions. Other embodiments may be implemented as software modules executed by a programmable control device. The storage medium may be non-transitory.

User device 102 may be configured to communicate with network 106, digital sign(s) 108a, . . . , 108n and/or digital sign management service 104 using a variety of communication protocols. The communications protocols may include but are not limited to wireless communications protocols, such as NFC, RFID, Wi-Fi, Bluetooth, 3G, 4G and/or other communication protocols. The Wi-Fi protocol may comply or be compatible with the 802.11 standards published by the Institute of Electrical and Electronics Engineers (IEEE), titled “IEEE 802.11-2007 Standard, IEEE Standard for Information Technology-Telecommunications and Information Exchange Between Systems-Local and Metropolitan Area Networks-Specific Requirements—Part 11: Wireless LAN Medium Access Control (MAC) and Physical Layer (PHY) Specifications” published, Mar. 8, 2007, and/or later versions of this standard.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The 3G protocol may comply or be compatible with the International Mobile Telecommunications (IMT) standard published by the International Telecommunication Union (ITU), titled “IMT-2000”, published in 2000, and/or later versions of this standard. The 4G protocol may comply or be compatible with IMT standard published by the ITU, titled “IMT-Advanced”, published in 2008, and/or later versions of this standard.

For example, network 106 may comprise a packet switched network. Userdevice(s) 102a, . . . , 102m and/or digital sign(s) 108a, . . . , 108n may be capable of communicating with the digital sign management service 104 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, userdevice(s) 102a, . . . , 102m and/or digital sign(s) 108a, . . . , 108n may be capable of communicating with the digital sign management service 104, using an X.25 communications protocol. The X.25 communications protocol may comply or be compatible with a standard promulgated by the International Telecommunication Union-Telecommunication Standardization Sector (ITU-T). Alternatively or additionally, userdevice(s) 102a, . . . , 102m and/or digital sign(s) 108a, . . . , 108n may be capable of communicating with the digital sign management service 104, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, userdevice(s) 102a, . . . , 102m and/or digital sign(s) 108a, . . . , 108n may be capable of communicating with the digital sign management service 104 using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An application (“app”) and/or a module, as used in any embodiment herein, may be embodied as circuitry. The circuitry may be embodied as an integrated circuit, such as an integrated circuit chip.

Thus, the present disclosure provides a method and system for user management of content displayed on digital sign(s). The managing may be performed by a user using a user computing device coupled to a digital sign management service and/or digital sign. The user may conveniently and efficiently access a plurality of digital signs at potentially diverse geographic locations for scheduling. The user may then easily manage and/or change displayed content in scheduled time slot(s) without a cumbersome renegotiation process.

According to one aspect there is provided an apparatus. The apparatus may include a user device. The user device may include processor circuitry coupled to communication circuitry, the communication circuitry configured to couple the user device to at least one of a digital sign and a management service, and the user device configured to manage display of user content on the digital sign, the user content configured to be displayed on the digital sign in a time slot.

Another example apparatus includes the forgoing components and the user device is further configured to submit the user content for approval.

Another example apparatus includes the forgoing components and the user device is further configured to bid for the time slot, a price of the time slot corresponding to a highest bid.

Another example apparatus includes the forgoing components and the user device is further configured to select the digital sign from a plurality of digital signs.

Another example apparatus includes the forgoing components and the user content comprises advertising content.

Another example apparatus includes the forgoing components and the user device is configured to manage the display of user content by at least one of adjusting an order of the display of the user content in the time slot and replacing at least a portion of the user content with new content configured to be displayed in the time slot.

Another example apparatus includes the forgoing components and the user content corresponds to a live event and the approval is provided during display of the user content on the digital sign.

Another example apparatus includes the forgoing components and the approval is based on at least one location characteristic associated with the digital sign.

According to another aspect there is provided a system. The system may include a user device, a digital sign and a management service. The user device may include processor circuitry coupled to communication circuitry. The digital sign may include a display and memory circuitry, the digital sign configured to store user content in the memory circuitry and to display the user content in a time slot. The communication circuitry is configured to couple the user device to at least one of the digital sign and the management service, and the user device is configured to manage display of the user content on the digital sign, the user content configured to be displayed on the digital sign in the time slot.

Another example system includes the forgoing components and the user device is further configured to submit the user content to the management service for approval.

Another example system includes the forgoing components and the user device is further configured to bid for the time slot, a price of the time slot corresponding to a highest bid.

Another example system includes the forgoing components and the user device is further configured to select the digital sign from a plurality of digital signs.

Another example system includes the forgoing components and the user content comprises advertising content.

Another example system includes the forgoing components and the user device is configured to manage the display of user content by at least one of adjusting an order of the display of the user content in the time slot and replacing at least a portion of the user content stored in the memory circuitry with new content configured for display in the time slot.

Another example system includes the forgoing components and the user content corresponds to a live event and the approval is provided during display of the user content on the digital sign.

Another example system includes the forgoing components and the approval is based on at least one location characteristic associated with the digital sign.

According to another aspect there is provided a method. The method may include coupling a user device to at least one of a digital sign and a management service; and managing a display of user content on the digital sign using the user device, the user content configured to be displayed on the digital sign in a time slot.

Another example method includes the forgoing operations and further includes submitting the user content for approval.

Another example method includes the forgoing operations and further includes bidding for the time slot, a price of the time slot corresponding to a highest bid.

Another example method includes the forgoing operations and further includes selecting the digital sign from a plurality of digital signs.

Another example method includes the forgoing operations and the user content includes advertising content.

Another example method includes the forgoing operations and the managing the display of user content includes at least one of adjusting an order of the display of the user content in the time slot and replacing at least a portion of the user content with new content configured to be displayed in the time slot.

Another example method includes the forgoing operations and the user content corresponds to a live event and the approval is provided during display of the user content on the digital sign.

Another example method includes the forgoing operations and the approval is based on at least one location characteristic associated with the digital sign.

According to another aspect there is provided a system. The system may include one or more storage mediums having stored thereon, individually or in combination, instructions that when executed by one or more processors result in the following operations comprising: coupling a user device to at least one of a digital sign and a management service; and managing a display of user content on the digital sign using the user device, the user content configured to be displayed on the digital sign in a time slot.

Another example system includes instructions that when executed by one or more processors result in the forgoing operations and also includes the following additional operation:submitting the user content for approval.

Another example system includes instructions that when executed by one or more processors result in the forgoing operations and also includes the following additional operations:bidding for the time slot, a price of the time slot corresponding to a highest bid.

Another example system includes instructions that when executed by one or more processors result in the forgoing operations and also includes the following additional operations:selecting the digital sign from a plurality of digital signs.

Another example system includes instructions that when executed by one or more processors result in the forgoing operations and the user content includes advertising content.

Another example system includes instructions that when executed by one or more processors result in the forgoing operations and also includes that the managing the display of user content comprises at least one of adjusting an order of the display of the user content in the time slot and replacing at least a portion of the user content with new content configured to be displayed in the time slot.

Another example system includes instructions that when executed by one or more processors result in the forgoing operations and also includes that the user content corresponds to a live event and the approval is provided during display of the user content on the digital sign.

Another example system includes instructions that when executed by one or more processors result in the forgoing operations and also includes that the approval is based on at least one location characteristic associated with the digital sign.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1.-25. (canceled)

26. An apparatus comprising:
a user device comprising processor circuitry coupled to communication circuitry,
the communication circuitry configured to couple the user device to at least one of a digital sign and a management service, and
the user device configured to manage display of user content on the digital sign, the user content configured to be displayed on the digital sign in a time slot.

27. The apparatus of claim 26, wherein the user device is further configured to submit the user content for approval.

28. The apparatus of claim 26, wherein the user device is further configured to bid for the time slot, a price of the time slot corresponding to a highest bid.

29. The apparatus of claim 26, wherein the user device is further configured to select the digital sign from a plurality of digital signs.

30. The apparatus of claim 26, wherein the user content comprises advertising content.

31. The apparatus of claim 26, wherein the user device is configured to manage the display of user content by at least one of adjusting an order of the display of the user content in the time slot and replacing at least a portion of the user content with new content configured to be displayed in the time slot.

32. The apparatus of claim 27, wherein the user content corresponds to a live event and the approval is provided during display of the user content on the digital sign.

33. The apparatus of claim 27, wherein the approval is based on at least one location characteristic associated with the digital sign.

34. A system, comprising:
a user device comprising processor circuitry coupled to communication circuitry;
a digital sign comprising a display and memory circuitry, the digital sign configured to store user content in the memory circuitry and to display the user content in a time slot; and
a management service,
the communication circuitry configured to couple the user device to at least one of the digital sign and the management service, and
the user device configured to manage display of the user content on the digital sign, the user content configured to be displayed on the digital sign in the time slot.

35. The system of claim 34, wherein the user device is further configured to submit the user content to the management service for approval.

36. The system of claim 34, wherein the user device is further configured to bid for the time slot, a price of the time slot corresponding to a highest bid.

37. The system of claim 34, wherein the user device is further configured to select the digital sign from a plurality of digital signs.

38. The system of claim 34, wherein the user content comprises advertising content.

39. The system of claim 34, wherein the user device is configured to manage the display of user content by at least one of adjusting an order of the display of the user content in the time slot and replacing at least a portion of the user content stored in the memory circuitry with new content configured for display in the time slot.

40. The system of claim 35, wherein the user content corresponds to a live event and the approval is provided during display of the user content on the digital sign.

41. The system of claim 35, wherein the approval is based on at least one location characteristic associated with the digital sign.

42. A method comprising:
coupling a user device to at least one of a digital sign and a management service; and
managing a display of user content on the digital sign using the user device, the user content configured to be displayed on the digital sign in a time slot.

43. The method of claim 42, further comprising:
submitting the user content for approval.

44. The method of claim 42, further comprising:
bidding for the time slot, a price of the time slot corresponding to a highest bid.

45. The method of claim 42, further comprising:
selecting the digital sign from a plurality of digital signs.

46. The method of claim 42, wherein the user content comprises advertising content.

47. The method of claim 42, wherein the managing the display of user content comprises at least one of adjusting an order of the display of the user content in the time slot and replacing at least a portion of the user content with new content configured to be displayed in the time slot.

48. The method of claim 43, wherein the user content corresponds to a live event and the approval is provided during display of the user content on the digital sign.

49. The method of claim 43, wherein the approval is based on at least one location characteristic associated with the digital sign.

50. A system comprising one or more storage mediums having stored thereon, individually or in combination, instructions that when executed by one or more processors result in the following operations comprising:
coupling a user device to at least one of a digital sign and a management service; and
managing a display of user content on the digital sign using the user device, the user content configured to be displayed on the digital sign in a time slot.

51. The system of claim 50, wherein the instructions that when executed by one or more processors results in the following additional operations:
submitting the user content for approval.

52. The system of claim 50, wherein the instructions that when executed by one or more processors results in the following additional operations:
bidding for the time slot, a price of the time slot corresponding to a highest bid.

53. The system of claim 50, wherein the instructions that when executed by one or more processors results in the following additional operations:
selecting the digital sign from a plurality of digital signs.

54. The system of claim 50, wherein the user content comprises advertising content.

55. The system of claim 50, wherein the managing the display of user content comprises at least one of adjusting an order of the display of the user content in the time slot and replacing at least a portion of the user content with new content configured to be displayed in the time slot.

56. The system of claim 51, wherein the user content corresponds to a live event and the approval is provided during display of the user content on the digital sign.

57. The system of claim 51, wherein the approval is based on at least one location characteristic associated with the digital sign.
